(19) United States
(12) Patent Application Publication
(10) Pub. No.: US 2008/0068268 A1
(43) Pub. Date: Mar. 20, 2008

(54) Low profile antenna

(76) Inventors: John V. Kowalewicz, Ortonville, MI (US); Ralf Lindackers, Waterford, MI (US); Andreas Fuchs, Grand Blanc, MI (US); Cheihk Thaim, Orion, MI (US)

Correspondence Address: HARNESS, DICKEY, & PIERCE, P.L.C, 7700 BONHOMME, STE 400, ST. LOUIS, MO, 63105, US

(21) Appl. No.: 11/521,228

(22) Filed: Sep. 14, 2006

(51) Int. Cl. H01Q 1/38

(52) U.S. Cl. 343/700 MS; 343/713

(57) ABSTRACT

A low-profile antenna according to exemplary embodiments generally includes a patch antenna enclosed in a housing, and a directional element for directing a direction of sensitivity for the patch antenna. The directional element is positioned on the external surface of the housing. A protective lens may be positioned over the directional element. In one exemplary embodiment, the directional element is formed from a layer of conductive material. In another exemplary embodiment, the directional element is formed from conductive ink containing silver particles.

### FIELD

The present disclosure relates to patch antennas.

### BACKGROUND

The statements in this section merely provide background information related to the present disclosure and may not constitute prior art.

A patch antenna is a narrowband, wide-beam antenna that includes an active antenna element bonded to a dielectric substrate. Patch antennas have a low profile compared to aerial antennas and are mechanically rugged. Patch antennas are therefore suitable for mounting on the exterior of vehicles to receive satellite signals, such as Satellite Digital Audio Radio Services (SDARS).

A patch antenna for automotive use is generally positioned on the roof, hood, or trunk lid to help ensure that the antenna has an unobstructed view overhead or towards the zenith. A receiving sensitivity or directivity of the antenna should also be directed towards the zenith. To this end, the patch antenna can include a passive director element that focuses the receiving sensitivity towards zenith.

Referring now to FIG. 1, a cross-sectional view is shown of a conventional patch antenna assembly 10 of the prior art. The assembly 10 includes a patch antenna 12 that is enclosed within a protective cover 14. A directional element 16 is positioned on an interior roof of the cover 14. The directional element 16 is concentric with the patch antenna 12 and increases directivity of the assembly 10 towards the zenith, which is indicated by an arrow Z.

An air gap between the patch antenna 12 and the directional element 16 has a height of H1. The magnitude of H1 is based on a center frequency of the patch antenna 12 and a desired degree of directional gain. The height H1 must be controlled when the patch antenna assembly 10 is assembled and thereafter remain stable to achieve and maintain the desired degree of directivity.

### SUMMARY

An antenna assembly includes a patch antenna that receives radio signals. A passive directional element increases the patch antenna gain in a particular direction. A protective cover shields the patch antenna from the environment. The patch antenna is positioned adjacent an interior surface of the protective cover, and the directional element is positioned on an exterior surface of the protective cover.

In other features, a distance between the interior and exterior surfaces is between about one millimeter and about two millimeters, inclusive. The directional element can be formed from aluminum. The directional element can be a conductive ink. The conductive ink can include silver particles. The directional element can include a graphic design. A protective shield can be positioned on the directional element. The protective shield can be between about 0.5 millimeter and about 2.5 millimeters thick, inclusive. The protective shield can be formed from transparent plastic. The protective cover can be formed from a dielectric material. The dielectric material can be a thermoplastic. The patch antenna is tuned to a center frequency between about 2.320 GHz and about 2.345 GHz, inclusive.

In one exemplary embodiment, an antenna assembly includes a patch antenna that receives radio signals. A cover is formed to define a space that houses the patch antenna. The cover includes an exterior surface that is exposed to the environment. A passive directional element is positioned on the exterior surface and cooperates with the patch antenna to establish a dominant direction of sensitivity for the antenna assembly.

In some features, a thickness of the cover between the patch antenna and the passive directional element is between about one millimeter and about two millimeters, inclusive. The directional element can be a conductive ink. The conductive ink may include silver particles. The antenna assembly can further include a transparent protective cover that is positioned on the directional element. The conductive ink may be printed on the transparent protective cover. The antenna assembly can further include an adhesive that adheres the directional element to the exterior surface of the cover.

In another exemplary embodiment, an antenna assembly includes a patch antenna that receives radio signals. A cover is formed to define a space that houses the patch antenna. The cover includes an exterior surface that is exposed to the environment. A decal assembly is positioned on the exterior surface of the cover. The cover includes a dielectric material. A directional element is formed of conductive ink printed on the dielectric material. An adhesive is applied to the directional element that adheres to the exterior surface of the cover.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 illustrates a cross sectional view of a prior art patch antenna assembly;

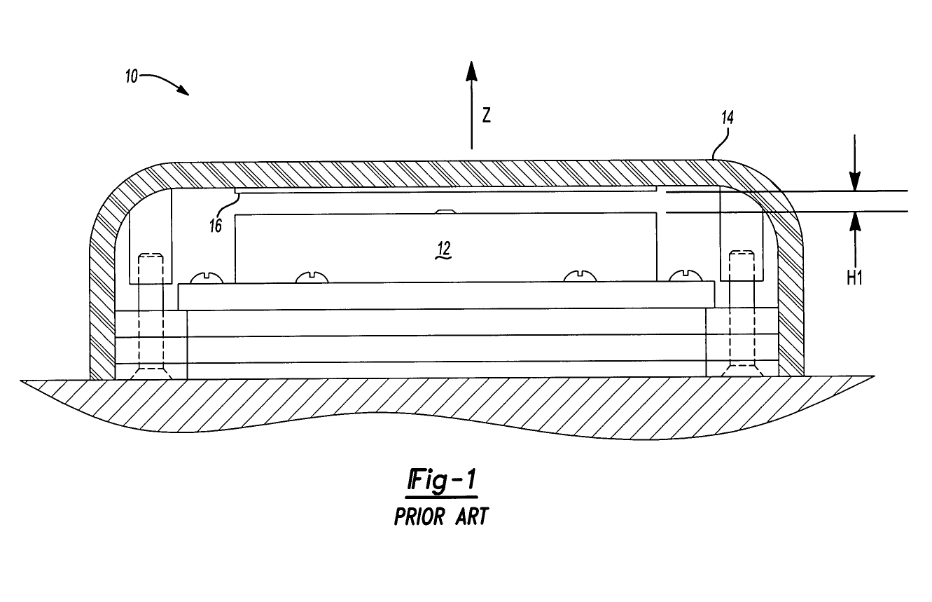

FIG. 2 illustrates a perspective view of an improved patch antenna assembly;

FIG. 3 illustrates a cross sectional view of the improved patch antenna assembly of FIG. 2; and

FIG. 4 illustrates an exploded view of the improved patch antenna assembly of FIG. 2.

### DETAILED DESCRIPTION

The following description is merely exemplary in nature and is not intended to limit the present disclosure, application, or uses.

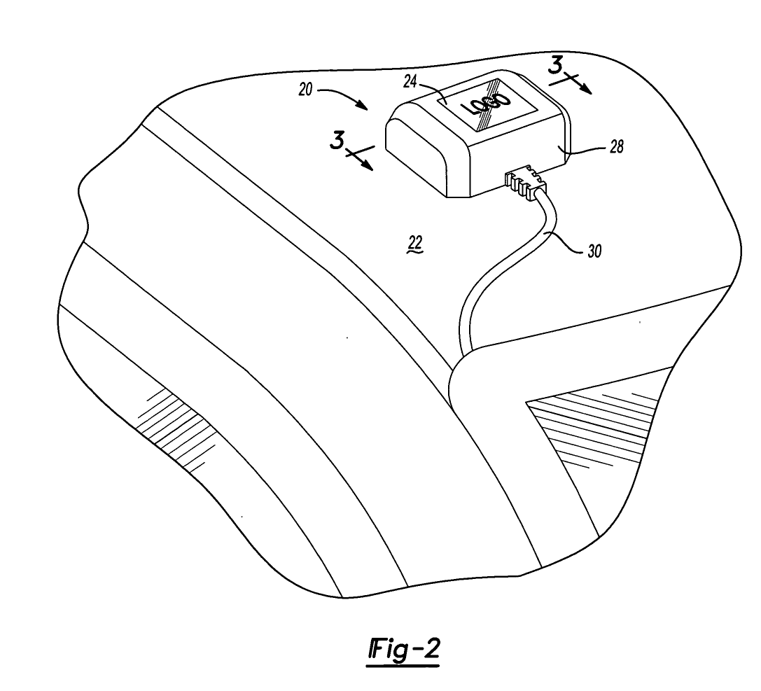

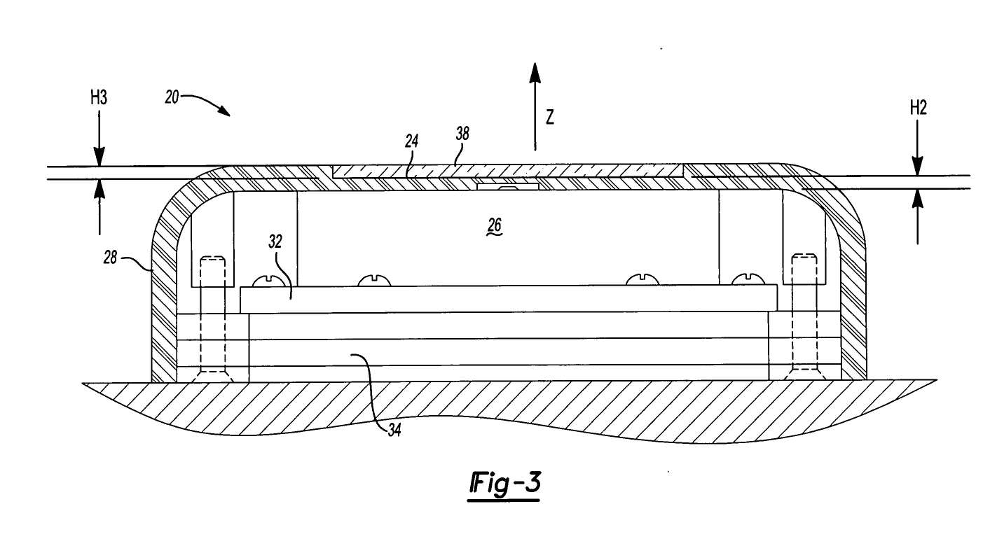

Referring now to FIG. 2, an improved patch antenna assembly 20 is shown positioned on a vehicle roof 22. In preferred embodiments, the improved antenna assembly 20 can provide a lower overall height than prior art patch antenna assemblies for similar applications. In addition, the improved antenna assembly 20 can also provide improved dimension control for a distance between a passive directional element 24 and a patch antenna 26 (shown in FIG. 3) that is located within a housing 28. A cable 30, such as a suitable coaxial cable, communicates received signals from the assembly 20 to a radio receiver (not shown). The housing 28 can be formed from a thermoplastic, such as GE Plastics Geloy® XP4034 Resin, although other suitable or equivalent materials can be used for the housing 28.

Referring now to FIG. 3, a cross-sectional view is shown of assembly 20 and taken along the section line 3-3 shown in FIG. 2. The patch antenna 26 is positioned on a circuit board 32. The circuit board 32 is secured to a chassis 34. In some embodiments, the chassis 34 is die cast from zinc. The housing 28 encloses the aforementioned items.

The directional element 24 can be positioned on an external surface of the housing 28. In some embodiments, a protective layer or shield 38 protects the directional element 24 from weather and the elements. In some embodiments, a conductive ink can be used to print the directional element 24 on one surface of the protective layer 38. In some embodiments, the conductive ink can include silver particles. In other embodiments, the directional element 24 can be formed from one or more layers of electrically-conductive material, such as a metallic tape. In further embodiments, the directional element 24 can be formed from sheet aluminum. In still other embodiments, the protective layer 38 is formed from urethane or an equivalent material. In some embodiments, the protective layer 38 is transparent. Alternatively, other embodiments can include a protective layer 38 that is substantially transparent or translucent.

With continued reference to FIG. 3, a portion of the housing 28 has a thickness H2 and is sandwiched between the patch antenna 26 and the directional element 24. In this particular embodiment, the sandwiched portion of the housing 28 improves the dimensional control and stability between the patch antenna 26 and the directional element 24. The distance H2 is preferably based on the wavelength of the frequencies received by the antenna assembly 20. In some embodiments, such as for frequencies currently used with SDARS, the thickness H2 is between about one millimeter and about two millimeters, inclusive. For example, one embodiment includes a thickness H2 of one millimeter. Another embodiment includes a thickness H2 of two millimeters. Still further embodiments can include a thickness H2 that is slightly less than one millimeter, slightly more than one millimeter, or somewhere in-between one millimeter and two millimeters.

The protective layer 38 has a thickness H3 for limiting capacitive coupling between the directional element 24 and environmental moisture. Capacitive coupling can degrade the reception performance of the antenna assembly 20. In some embodiments, the thickness H3 is between about 0.5 millimeter and about 2.5 millimeters, inclusive. For example, one embodiment includes a thickness H3 of 0.5 millimeter. Another embodiment includes a thickness H3 of 2.5 millimeters. Still further embodiments can include a thickness H3 that is slightly less than 0.5 millimeter, slightly more than 2.5 millimeters, or somewhere in-between 0.5 millimeter and 2.5 millimeters. In some embodiments a thickness H3 of 1.43 millimeters is preferred.

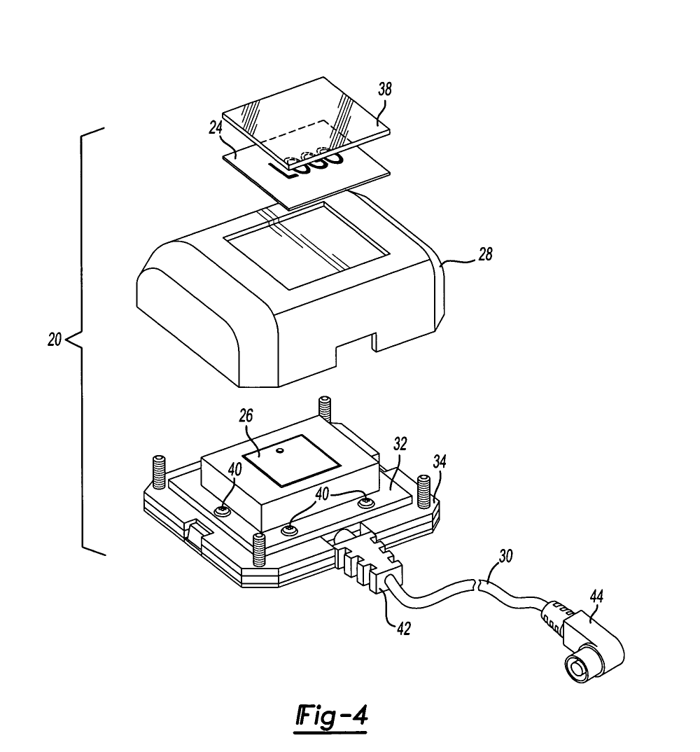

Referring now to FIG. 4, an exploded view is shown of the antenna assembly 20. In this illustrated embodiment, the printed circuit board 32 can be secured with screws 40 to the chassis 34. Alternatively, the printed circuit board 32 may be secured using other suitable means.

One end of the coaxial cable 30 can include a strain relief 42 that interfaces with the chassis 34 and housing or protective cover 28. The other end of cable 30 can include a connector 44 that mates with a radio receiver (not shown).

The directional element 24 can include text, a logo, a graphic element, or other indicia. In some embodiments, the directional element 24 is printed on one surface of the protective shield 38. An adhesive is then applied to the otherwise exposed surface of the printed directional element 24. The protective shield 38, directional element 24, and the adhesive are thereby layered and form a decal that can be adhered to the protective housing or cover 28.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order or performance. It is also to be understood that additional or alternative steps may be employed.

Those skilled in the art can now appreciate from the foregoing description that the broad teachings of the disclosure can be implemented in a variety of forms. Therefore, while this disclosure includes particular examples, the true scope of the disclosure should not be so limited since other modifications will become apparent to the skilled practitioner upon a study of the drawings, the specification and the following claims.

1. An antenna assembly comprising:
a patch antenna for receiving radio signals;
a passive directional element for increasing patch antenna gain in a particular direction;
a protective cover for shielding the patch antenna from the environment,the patch antenna positioned adjacent an interior surface of the protective cover, the directional element positioned on an exterior surface of the protective cover; and
a protective shield positioned on and forming a lens over the passive directional element.

2. The antenna assembly of claim 1, the protective cover comprising at least one thickness based on a wavelength of the radio signals.

3. The antenna assembly of claim 1, wherein one of the at least one thickness is between about one millimeter and about two millimeters, inclusive.

4. The antenna assembly of claim 3, wherein one of the at least one thickness is one millimeter.

5. The antenna assembly of claim 3, wherein one of the at least one thickness is two millimeters.

6. The antenna assembly of claim 2, wherein a first portion of the protective cover is positioned over an active antenna element of the patch antenna, and a second portion of the protective cover upper portion is positioned around the active antenna element.

7. The antenna assembly of claim 1, wherein the passive directional element is formed from aluminum.

8. The antenna assembly of claim 1, wherein the passive directional element includes a conductive ink.

9. The antenna assembly of claim 8, wherein the conductive ink includes silver particles.

10. The antenna assembly of claim 8, wherein the passive directional element includes a graphic design.

11. The antenna of claim 1, the protective shield having a thickness configured to limit capacitive coupling between the passive directional element and moisture.

12. The antenna of claim 11, wherein the protective shield is between about 0.5 millimeter and 2.5 millimeters thick, inclusive.

13. The antenna assembly of claim 12, wherein the protective shield is 0.5 millimeter thick.

14. The antenna assembly of claim 12, wherein the protective shield is 2.5 millimeters thick.

15. The antenna assembly of claim 12, wherein the protective shield is 1.43 millimeters thick.

16. The antenna of claim 11, wherein the protective shield is formed from a substantially transparent material.

17. The antenna of claim 11, wherein the protective shield is formed from a dielectric material.

18. The antenna of claim 17, wherein the dielectric material includes a thermoplastic.

19. The antenna of claim 1, wherein the patch antenna includes a center frequency between about 2.320 GHz and about 2.345 GHz, inclusive.

20. An antenna assembly comprising:
a circuit board mounted on a chassis;
a patch antenna for receiving radio signals, the patch antenna mounted on the circuit board;
a cover mounted to the chassis and covering the patch antenna and circuit board the cover having an upper portion at least part of which is disposed on an upper surface of the patch antenna around an active antenna element of the patch antenna;
a passive directional element positioned on the upper portion of the cover, substantially concentric with the patch antenna, and that cooperates with the patch antenna to establish a dominant direction of sensitivity for the antenna assmebly; and
a substantially transoarent protective shield embedded in the cover upper portion over the passive directional element, the shield having a thickness configured to limit capacitive coupling between the passive directional element and moisture.

21. The antenna assembly of claim 20, wherein a thickness of the cover between the patch antenna and the passive directional element is between about one millimeter and about two millimeters, inclusive.

22. The antenna assembly of claim 20, wherein the passive directional element includes a conductive ink.

23. The antenna assembly of claim 22, wherein the conductive ink includes silver particles.

24. The antenna assembly of claim 20, the shield forming a lens over the passive directional element.

25. The antenna assembly of claim 24, wherein the passive directional element is printed on the transparent protective shield.

26. The antenna assembly of claim 21, mounted on a roof of a vehicle.

27. An antenna assembly comprising:
a patch antenna for receiving radio signals;
a cover covering the patch antenna; and
a decal assembly positioned on an exterior surface of the cover, the decal assembly including:
a dielectric material having an upper surface that is exposed to the environment;
a directional element that is formed of conductive ink printed on the dielectric material, the dielectric material forming a lens over the directional element and configured to limit capacitive coupling between the directional element and the environment; and
an adhesive that is applied to the directional element and that adheres to the exterior surface of the cover.
